(19) United States
(12) Patent Application Publication
(10) Pub. No.: US 2005/0131637 A1
(43) Pub. Date: Jun. 16, 2005

(54) Method of constructing personal map database for generating personal map

(76) Inventors: Hsiao-Wei Chu, TAIPEI HSIEN (TW); Chih-Hao Lin, TAIPEI CITY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,299

(22) Filed: Feb. 23, 2004

(30) Foreign Application Priority Data
Dec. 15, 2003 (TW) 92135341

(51) Int. Cl. G01C 21/30

(52) U.S. Cl. 701/208; 340/995.1

(57) ABSTRACT

A method of constructing a personal map database is provided. A positioning device having a positioning functionality, installed in an automobile is provided. The automobile is set into motion along a path heading towards a destination. A plurality of positions are recorded, wherein each recorded position comprises information including a distance of current position relative to a starting point and time to create a positioning data. A personal map database is generated using the positioning data. The personal map database can be downloaded to any positioning device and can be used to generate a personal map leading to the recreation spot of interest contained in the personal map database.

### CROSS REFERENCE TO RELATED APPLICATIONS

This application claims the priority benefit of Taiwan application serial no.92135341, filed on Dec. 15, 2003.

### BACKGROUND OF INVENTION

1. Field of the Invention

The present invention relates to a method of constructing a personal map database, and more particularly, to a method of constructing a personal map database using a Global Positioning System (GPS) for generating a personal map.

2. Description of Related Art

Thanks to the improvement of the life quality in recent years, our people gradually think highly of recreation and traveling, and the tendency of journey is also gradually accepted by families at large. In the past, if someone likes to visit a recreation area where he/she is not familiar with, it is common that he/she can obtain limited information from limited resources such as friends or the broadcasting media. However, due to lack information regarding the traffic status towards the destination and routes to the destination, one may get into a lot of trouble such as meeting with the traffic jam or getting lost. This would significantly impact the mood of the journey and also wastes a great amount of efforts and time.

Fortunately, thanks to the development of the Global Positioning System (GPS), making it possible to get the navigation information leading to the destination in advance by using the satellite detecting technique. In addition, since the GPS technique has been further improved and the price of the GPS product has fallen to an acceptable and affordable level to public recently. Some automobile vendors have equipped the GPS as its standard equipment in the new cars. Therefore, since the GPS is more popular and widely used now, it is no longer a big concern when the user wishes to visit any destination.

Some people face a common problem, such as, even though there is a recreation spot really worth visiting, however, in a case when the area where the recreation spot is located is quite big, it is very hard to navigate to the exact recreation spot, even in a situation when we have the specific map or address in hand.

### SUMMARY OF INVENTION

According to an embodiment of the present invention, a method for constructing a personal map database which allows the use of photos to search the personal map leading to recreation spots of interest is provided.

According to another embodiment of the present invention, a general user can use a positioning system to download the personal map database mentioned above, which would search the personal map and lead the general user to the recreation spot indicated in the personal map which has been visited by others before.

In accordance with the embodiments mentioned above and other advantages, the present invention provides a method for constructing a personal map database. In the present embodiment, any device having positioning functionality and a digital camera can be used for constructing the personal map database. As it is well known, when the positioning device is activated, a guide map is displayed showing the current location of positioning device with time as the starting point, the destination as the end point and a favorable route or path leading to the destination point. In addition, other related information, such as time/distance lapsed and approximate time/distance remaining to the destination are also displayed on the display screen. When the user reaches a destination or recreation spot, this position is recorded as a point and stored in the positioning device. Likewise, when the user visits several destination or recreation spots or places of interest, all these positions are recorded as points and stored in the positioning device. Further, the user may take one or more pictures at one or more destinations points and the pictures can be used as an index for searching the personal map leading to destination points. In addition, the time when point is recorded is also recorded, and also the time when the picture is taken is also recorded. The above information is used to construct a personal map database. A personal map is generated using the personal map database.

According to an embodiment of the present invention, the method of constructing the personal map database comprises: providing positioning device having a positioning functionality that can be installed in an automobile; installing the positioning device in the automobile; setting the automobile into motion along a path heading towards a destination; recording a plurality of points with information including a time at which the corresponding point is recorded; and generating a map using the positioning data.

According to an embodiment of the present invention, the plurality of points are the positions where the destinations or recreation spots visited by the user are located.

According to an embodiment of the present invention, the step of recording points is accomplished via manual recording operation.

According to an embodiment of the present invention, the step of recording the plurality of points is accomplished via automatic recording operation at a preset parameter, such as, at predetermined interval of time or at predetermined interval of distance.

According to an embodiment of the present invention, the picture taken at one or more locations corresponding to a point of recording.

According to an embodiment of the present invention, the picture is taken at one or more locations along the route or path taken by the user regardless of the recording points.

According to an embodiment of the present invention, the picture is merged into the positioning data to generate the personal map database, and the picture is used as a search index in the subsequent searching process.

According to an embodiment of the present invention, the picture(s) is/are merged by using a software provided by the present invention.

According to an embodiment of the present invention, the pictures of recreation spots, which serve as search indices are displayed on the display screen where a user may select one or more pictures to retrieve the personal map leading to the selected recreation spots. Upon selecting a picture of interest, the personal positioning database is searched according to the time record of the picture. During the search, when a time record of a point is found to match with the time record of the picture, then a personal map is retrieved with a coordinate showing the recorded point corresponding to the recreation spot indicated by the picture. On the other hand, when the time record of the picture is found not to match with any of the recorded points, then a time range between two recorded points within which the time record of the picture falls is searched and then the time between the two recorded points corresponding to time record of the picture is calculated according to the time range between the two recorded points, and then a personal map is retrieved with a coordinate showing the recreation spot indicated by the picture.

According to an embodiment of the present invention, when the coordinate is clicked, the picture with related information, such as the distance from the current position, is displayed on the display screen.

Moreover, before the step of searching of the personal map leading to the recreation spots of interest, the positioning data and the picture(s) mentioned above are uploaded into a data processing device, such as, a Personal Computer (PC), a Personal Digital Assistance (PDA) or a portable computer, wherein the positioning data and the pictures are merged using a software provided by the present invention.

According to an embodiment of the present invention, the picture is a digital picture taken by using a digital camera.

According to an embodiment of the present invention, the positioning device mentioned above is a mobile device having the GPS function.

According to an embodiment of the present invention, the personal positioning database can be down loaded into any other device having GPS functionality.

According to an embodiment of the present invention, the device with GPS functionality may be a PDA, or a carinstalled GPS device.

In summary, the positions where the recreation spots are located are marked by visiting the recreation spots and recording these points and the time, and pictures of the recreation spots in these locations are taken by using a digital camera so that the time the picture was taken can also be recorded to subsequently serve as search index for generating the personal map leading to the selected destination (pictures correspond to destinations). It is to be understood that the picture may be later modified as desired by using some special software.

### BRIEF DESCRIPTION OF DRAWINGS

The accompanying drawings are included to provide a further understanding of the invention, and are incorporated in and constitute a part of this specification. The following drawings illustrate embodiments of the invention, and together with the description, serve to explain the principles of the invention.

FIG. 1A is a flow chart illustrating a method of constructing a personal map database according to a preferred embodiment of the present invention.

FIG. 1B is a personal map generated using the personal map database according to a preferred embodiment of the present invention.

FIG. 1C is a personal map generated using the personal map database having higher density of recorded points according to a preferred embodiment of the present invention.

FIG. 2A is a flow chart illustrating a method for generating a personal map using a mobile positioning device according to an embodiment of the present invention.

FIG. 2B is a flow chart illustrating a method of generating a personal map a positioning device according to another embodiment of the present invention.

FIG. 3 is a flow chart illustrating a method of searching a personal map based on the time the picture is taken according to a preferred embodiment of the present invention.

FIG. 4A is a diagram illustrating a device for downloading and displaying a personal map according to an embodiment of the present invention.

FIG. 4B schematically shows a personal map according an embodiment of the present invention.

### DETAILED DESCRIPTION

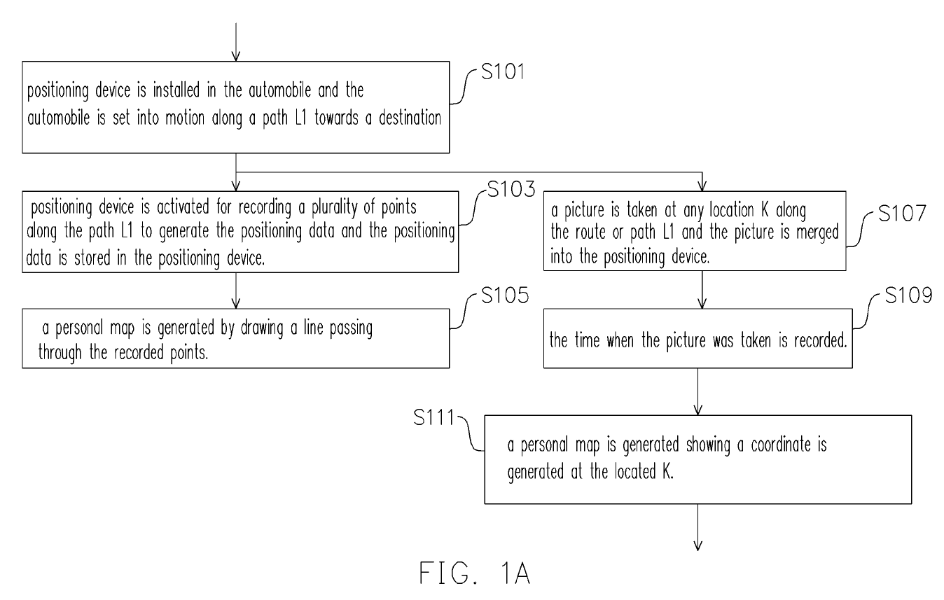

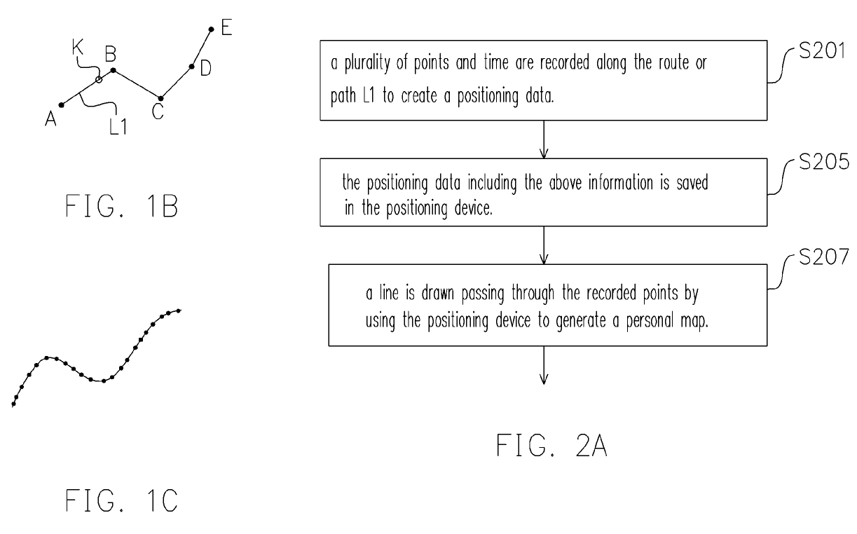

FIG. 1A is a flow chart illustrating a method of constructing a personal map database according to a preferred embodiment of the present invention. Referring to FIG. 1A, the method of the present invention uses a positioning device, for example, the mobile device such as a PDA with the GPS function or a car-installed GPS device that can be installed in an automobile. In step S101, when the positioning device is activated to initiate the navigation guide course, the positioning device is set to record a plurality of points and time respectively representing the location or the position visited and the time when these locations were visited.

In step S103, the above information is stored as a positioning data in the positioning device. The positioning data comprises a plurality of points and time recorded along the route or path L1 corresponding to the position of the positioning device as shown in FIG. 1B. As shown in FIG. 1B, the positioning data comprises points A, B, C, D, E indicating the position of the positioning device and the corresponding time, and the format of each recording point is (x, y, h, t). Wherein, x and y represents a longitude and a longitude on the earth surface where the recording point is located, respectively, h represents a altitude of the recording point, and t represents a time the user was on the point. Accordingly, a line passing through the points A, B, C, D and E indicate the path or the route taken the user. Thus, a personal map is generated by drawing a line passing through the points A, B, C, D and E as shown in step S105. It will be easily understood by those skilled in the art that the more recording points are between the starting point and the destination point, the map obtained by drawing a line passing through these points would more precisely reflect to the actual route or path taken by the user as shown in FIG. 1C. Further, the recorded points marks the recreation spots of interest.

Referring to FIG. 1A, in step S107, optionally, a picture is taken at any location K along the route or path L1, as shown in FIG. 1B. In step S109, the time when the picture was taken is recorded. In the present embodiment, a digital camera is used to take the picture, thus the time when the picture is taken is automatically recorded and saved in each image file. Next, the picture is merged into the positioning data. Next, in step S111, a personal map is generated showing a coordinate at the location where the picture was taken on the personal map.

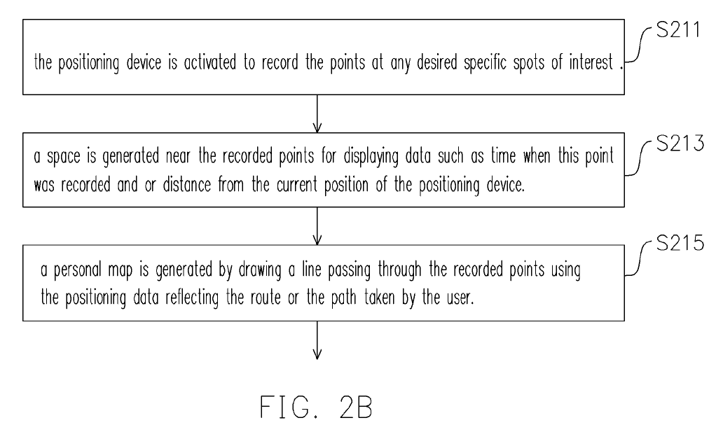

FIG. 2A is a flow chart illustrating a method of generating a personal map using a positioning device according to another embodiment of the present invention. In step S201, a plurality of points and time are recorded along the route or path taken by the user and stored in the positioning device according to the method described in the previous embodiment. The plurality of recorded points are recorded according to a preset parameter, for example, at a predetermined interval of time (e.g. every a couple of seconds or a couple of minutes) or at a predetermined interval of distance (e.g. a couple of meters). Next, in step S205, the positioning data including the above information is saved in the positioning device. Finally, in step S207, a line is drawn passing through the recorded points by using the positioning device to generate a personal map.

FIG. 2B is a flow chart illustrating a method of generating a personal map according to an embodiment of the present invention. Referring to FIG. 2B, the positioning device is used to record a plurality of points as described in the previous embodiment, however, unlike the previous embodiment, the points are manually recorded by the user. In this embodiment, in step S211, the user activates positioning device to record the points at any desired specific spots of interest. Next, in step S213, a space is generated near the recorded points for displaying data such as time when this point was recorded and or distance from the current position of the positioning device. Next, as shown in step S215, a personal map is generated by drawing a line passing through the recorded points using the positioning data reflecting the route or the path taken by the user.

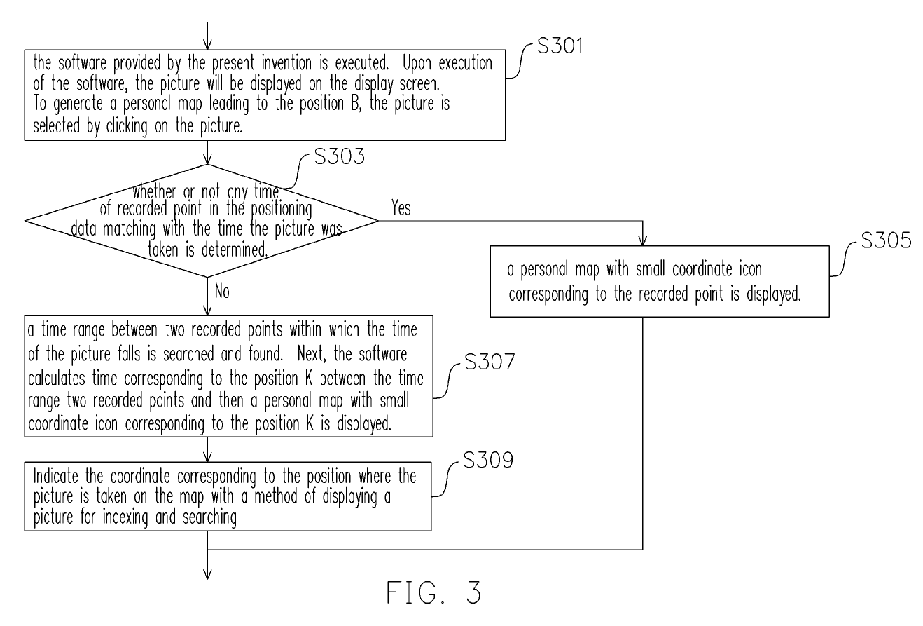

FIG. 3 is a flow chart illustrating a method of searching a personal map leading to the recreation spot of interest according to an embodiment of the present invention. The positioning data is uploaded into a data processing device. Next, the picture(s) taken by the digital camera is also uploaded into the data processing device. Next, the picture(s) is/are merged into the map by using a software. Thus, a personal map database is generated. The detailed description of generating the personal map database is described as follows. First, the picture taken at the position B along the path L1 shown in FIG. 1B is uploaded into the data processing device. Next, in step S301, the software provided by the present invention is executed. Upon execution of the software, the picture will be displayed on the display screen, and to generate a personal map leading to the position B, the picture is selected by clicking on the picture. In doing so, the positioning data is searched according to the time the picture was taken. In step S303, whether or not any time of recorded point in the positioning data matching with the time the picture was taken is determined. Next, if the time of the picture matches with a time of the recorded point, then step S305 is performed to generate a personal map with small coordinate icon corresponding to the recorded point, and this personal map is displayed. For example, if the time of the picture taken is 9:00 and the time of recorded point B is also 09:00, then a small icon on the coordinate corresponding to the recorded point B on the personal map or display a small icon near the coordinate is generated and displayed. The icon can be clicked to view the picture and other related information such as the distance from the current position.

On the other hand, if a picture at position K on the personal map shown in FIG. 1B is uploaded into the data processing device such as a personal computer, the specific software of the present invention performs step S301 to search a recorded point matching with the time the picture was taken. It is assumed that the time of the recorded point A was 08:30, the time of recorded point B was 09:00, and the time the picture at the position K was taken at 08:50. In step S303, because the time the picture taken does not match with time of any recorded points, and therefore step 307 is performed. In step S307, a time range between two recorded points within which the time of the picture falls is searched and found. Next, the software calculates time corresponding to the position K between the time range two recorded points. In other words, the software of the present invention determines the picture corresponding to position K is within a 30 minutes range between the two recorded points A and B based on the time of the picture and the time of the recorded points A and B. Next, in step S309, a personal map with a small icon is displayed on the coordinate or a small icon near the coordinate at the position K is generated and displayed. It is to be noted that one or more pictures, corresponding to one or more or all of creation spots or regardless of one or more recreation spots, can be taken and merged into the positioning database to serve as search indices. Further, one or more pictures can be selected to generate a personal map including one or more coordinate icons corresponding to the selected pictures which in turn correspond to the recreation spots of interest.

Although the embodiments described above include the use of a personal computer to generate the personal map database of the present invention, other equivalent devices such as a portable computer or other data processing device may also be used to generate the personal map database. It will be apparent to one of the ordinary skill in the art that modifications to the described embodiment may be made without departing from the scope and spirit of the invention.

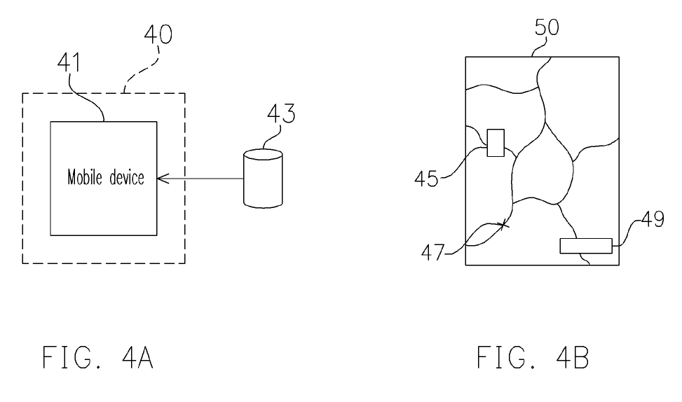

FIG. 4A is a diagram illustrating a device used for downloading and displaying a personal map database according to an embodiment of the present invention. Referring to FIG. 4A, a personal map database 43 constructed using the method of the present invention described above can be downloaded by any interested person using a positioning device 40, which can be used to generate a personal map leading to the recreation spot(s) of interest. In the present embodiment, the positioning device 40 is a mobile device 41 having the GPS function.

When a new user B wishes to visit the destinations in the personal map database 43, the user B could download the personal map database 43 into the positioning device 41 and execute the personal map database 43. As a result, pictures corresponding to recreation spots are displayed on the display screen. Next, a picture 45 is selected to generate a personal map 50 as shown in FIG. 4B and displayed on the screen of the mobile device 41. The personal map 50 comprises a plurality of recorded points including a coordinate icon at a position corresponding to picture 45 and a current position 47 of the positioning device 41. For example, the recording points are recreation spots recorded by the person who had constructed this personal map database using the method of the present invention described above. If the user B desires visiting the recreation spot indicated by the picture 45, the user B can take the route or path shown in the personal map 50, which can easily lead the user B to the recreation spot indicated by picture 45 in the personal map 50. In addition, in the present embodiment, when the picture 45 is clicked, information such as the distance from the current position 47 to the recreation spot corresponding to the picture 45 is displayed in the area 49.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method of constructing a personal map database, comprising:
providing positioning device having a positioning functionality installed in an automobile;
setting the automobile into motion along a path towards a destination;
recording a plurality of points along the path, wherein a time each point was recorded is recorded and the recorded points and the time are stored as a positioning data;
taking one or more pictures along the path to the destination;
merging the picture(s) into the positioning data to generate a personal map database; and
generating a personal map using the personal map database.

2. The method according to claim 1, further comprising the picture(s) are taken at one or more locations along the path corresponding to one or more recorded points, wherein the picture comprises a data including time the picture was taken.

3. The method according to claim 1, further comprising the picture(s) are taken at any at one or more locations along the path regardless of recorded points, wherein the picture comprises a data including time the picture was taken.

4. The method according to claim 2, wherein the picture is taken by using a digital camera.

5. The method according to claim 1, wherein the recorded points are automatically recorded at a predetermined interval of time.

6. The method according to claim 1, wherein the recorded points are automatically recorded at a predetermined interval of distance.

7. The method according to claim 1, wherein the recorded points are manually recorded.

8. The method according to claim 1, wherein the step of merging the picture(s) into the positioning database comprises:
uploading the positioning data into a data processing device;
uploading the pictures into the data processing device;
merging the pictures into the positioning data.

9. The method according to claim 1, further comprising a space is generated near each recorded points for displaying a time when the corresponding recorded points.

10. The method according to claim 8, wherein the data processing device is selected from a group consisting a Personal Computer (PC), a Personal Digital Assistance (PDA), and a portable computer.

11. The method according to claim 9, wherein the space near each recorded position include a time the recorded points were recorded and or a distance relative to the starting point or the current position of the positioning device.

12. The method according to claim 1, wherein the picture(s) represent one or more recreation spots.

13. The method according to claim 1, further comprising a step of searching a personal map leading to one or more recreation spots.

14. The method according to claim 13, wherein the step of searching the personal map leading to one or more recreation spots comprises:
executing a software for displaying the pictures representing one or more recreation spots;
selecting one or more pictures by clicking on the pictures to generate the personal map leading to the selected to recreation spots represented by the pictures, wherein a small icon is generated on or near a coordinate on locations corresponding to the selected recreation spots.

15. The method according to claim 14, the step of searching the personal map is implemented according to the time the picture was taken, wherein the time of the picture and the time of the recorded points are compared and calculated to find the position on the map corresponding to the time the picture was taken.

16. The method according to claim 14, wherein the step of searching the searching the personal map searching the positioning data for a time matching the time the picture was taken, wherein when a time of the recorded point matches with the time the picture was taken and the personal map leading to the matching recorded point is generated.

17. The method according to claim 14, wherein the step of searching the searching the personal map comprises searching the positioning data for a time matching the time the picture was taken, wherein when a time of the recorded point matching with the time the picture was taken is not found, a time range between two recorded point within which the time the picture was taken falls is retrieved and calculated to find a position between the two recorded points corresponding to the time the picture was taken and a coordinate on the map the personal map leading to the matching recorded point is generated.

18. The method according to claim 1, wherein the positioning device comprises a Personal Digital Assistance (PDA) or a standard automobile mobile device having GPS functionality.

19. A device for displaying a personal map, comprising:
a positioning device, having a GPS function; and
a downloadable personal map database, downloaded into the positioning device, wherein the personal map database comprises:
a positioning data, comprising a plurality of points along a path, wherein a time each point was recorded is recorded;
one or more pictures, taken along the path leading to one or more destinations represented by the pictures, wherein the pictures are merged in the positioning data using a software.

20. The device according to claim 19, wherein the positioning device comprises a PDA.

21. The device according to claim 19, wherein the positioning device comprises a standard automobile positioning device having GPS functionality.

22. The device according to claim 19, wherein the positioning device comprises a mobile phone system.
